(19) United States
(12) Patent Application Publication
(10) Pub. No.: US 2010/0262504 A1
(43) Pub. Date: Oct. 14, 2010

(54) POS TERMINAL

(75) Inventor: Yukihiro Tamura, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/749,596

(22) Filed: Mar. 30, 2010

(30) Foreign Application Priority Data
Apr. 8, 2009 (JP) 2009-094318

(51) Int. Cl. E04H 3/02; G06Q 30/00

(52) U.S. Cl. 705/24; 186/59; 705/16; 705/25

(57) ABSTRACT

A POS terminal includes a display unit including a display, a connecting mechanism configured to pivotably connect the display unit and a base unit, a detecting unit configured to detect a position of the pivoted display unit in plural predetermined positions, and a control unit configured to display information on the display when the display unit is located in any one of the predetermined positions.

### CROSS-REFERENCE TO RELATED APPLICATION

This application is based upon and claims the benefit of priority from the prior Japanese Patent Application No. 2009-094318, filed on Apr. 8, 2009, the entire contents of which are incorporated herein by reference.

### TECHNICAL FIELD

The present invention relates to a POS terminal including a variable display unit.

### BACKGROUND

A POS terminal used in a POS system includes a display unit having a display. In some POS terminals, the display unit pivots. The display has a touch panel function and also functions as an operation unit.

In a POS terminal in which the touch panel function of the display is used as the operation unit, it is unnecessary to separately provide the operation unit. The POS terminal is small in size. For example, in the POS terminal, the display including a touch panel is pivotably connected to a housing. In the POS terminal, the display unit is pivoted in a direction away from the housing. According to the pivoting of the display unit, in the POS terminal, a printer provided on the upper surface of the housing is exposed. For example, a direction in which the display unit is separated from the housing is an upward direction.

JP-A-2003-196595 discloses a card reader connected to a POS terminal and used. The card reader has a pivoting display unit. In the card reader, a tabular member that performs shielding swings in association with the pivoting display unit.

The POS terminal has problems explained below. Although the POS terminal can be operated from one direction, it is difficult to operate the POS terminal from the other direction. One direction is an operator side of the POS terminal. The other direction is a customer side. For example, when a customer operates the POS terminal, the customer moves to the front of the POS terminal. Alternatively, the customer moves the POS terminal to a position where the display is opposed to the customer.

However, when the POS terminal is fixed in a setting space, the POS terminal cannot be moved. It is difficult to operate the POS terminal, which is operated from one direction, from the other direction. Similarly, it is difficult to visually recognize the display, which is directed in one direction, from the other direction. Therefore, the use of the POS terminal is limited. A range in which the POS terminal can be operated and visually recognized is narrow.

### SUMMARY

It is an object of the present invention to provide a POS terminal with improved operability and visibility.

According to an aspect of the present invention, there is provided a POS terminal including: a base unit; a display unit including a display; a connecting mechanism configured to connect the display unit to the base unit, the display unit pivoting with respect to the base unit; a detecting unit configured to detect a position of the pivoted display unit in plural predetermined positions; and a control unit configured to display information on the display when the display unit is located in any one of the predetermined positions.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of the configuration of a POS terminal according to an embodiment of the present invention;

FIG. 2 is a perspective view of the configuration of the POS terminal;

FIG. 3 is an enlarged perspective view of a main part of the POS terminal;

FIG. 4 is an enlarged sectional view of the main part of the POS terminal;

FIG. 5 is a schematic block diagram of the configuration of the POS terminal; and

FIG. 6 is a flowchart for explaining the operation of the POS terminal.

### DETAILED DESCRIPTION

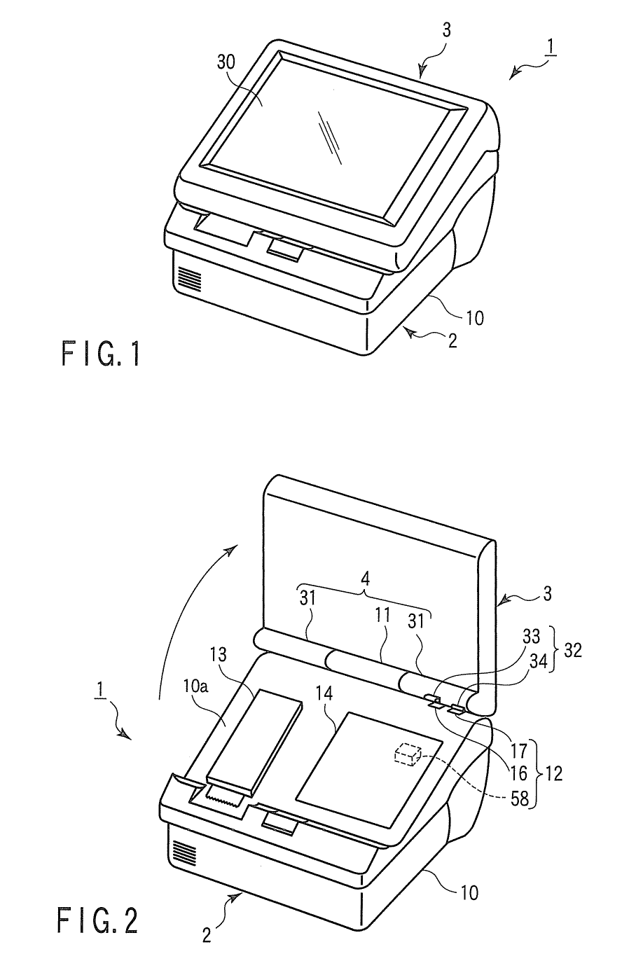

A POS terminal 1 according to an embodiment of the present invention is explained below with reference to FIGS. 1 to 6.

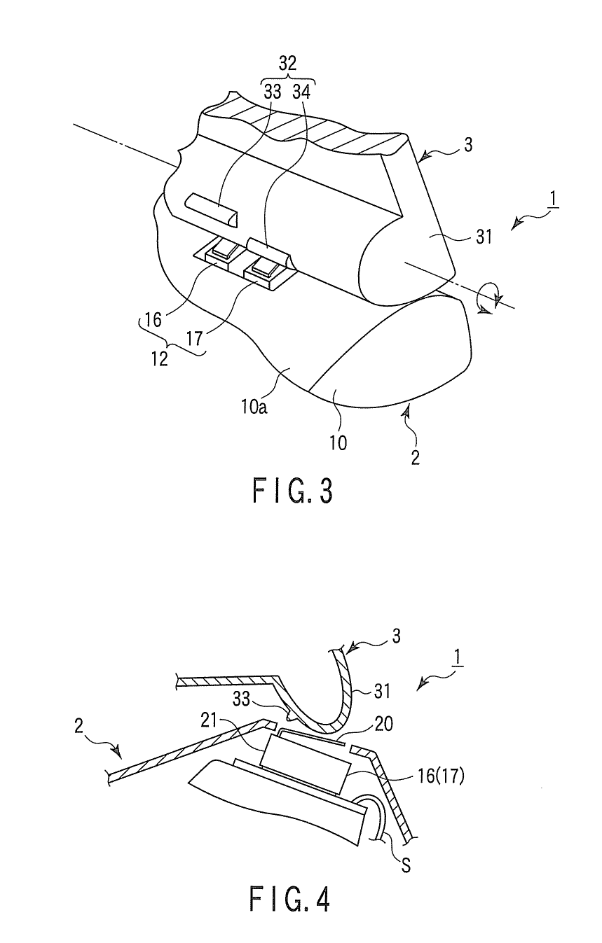

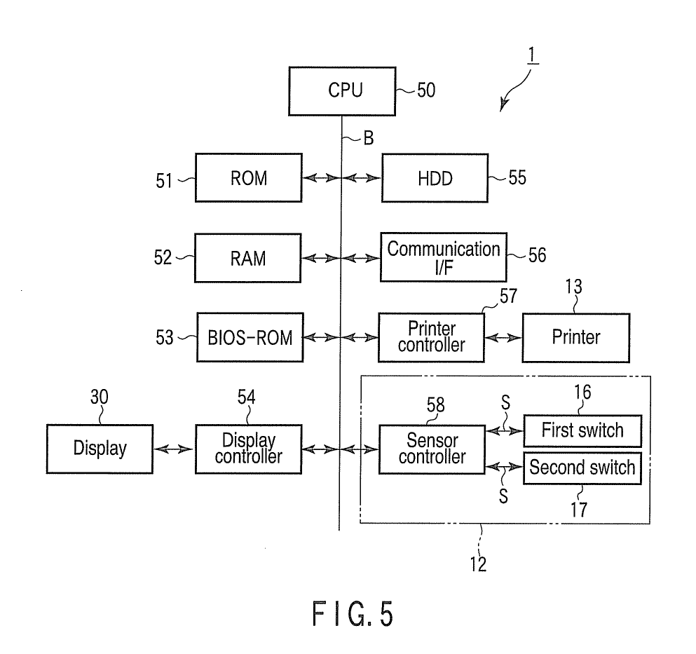

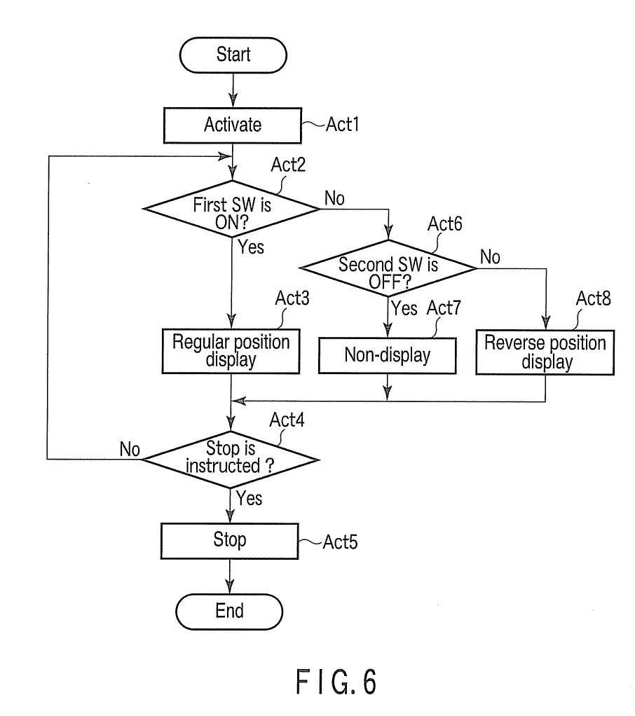

FIG. 1 is a perspective view of the configuration of the POS terminal 1 according to the embodiment. FIG. 2 is a perspective view of the configuration of the POS terminal 1. FIG. 3 is a perspective view of the configuration of a sensor unit 12 and operation sections 32 of the POS terminal 1. FIG. 4 is a partial sectional view of the configuration of the sensor unit 12 and the operation sections 32 of the POS terminal 1. FIG. 5 is a schematic block diagram of the configuration of the POS terminal 1. FIG. 6 is a flowchart for explaining an example of the operation of the POS terminal 1. In FIGS. 4 and 5, B indicates a bus line, C indicates an axis, and S indicates a signal line.

As shown in FIGS. 1 and 2, the POS terminal 1 includes a base unit 2, a display unit 3, and a connecting mechanism 4. The POS terminal 1 according to this embodiment is set in, for example, a setting space at a register counter in a store.

The base unit 2 includes a housing 10, a first connecting section 11, and the sensor unit 12.

The housing 10 includes a base plate and the like in the inside thereof. The housing 10 includes a printer 13 and an upper surface cover 14, which exposes the inside of the housing 10, on an upper surface 10a thereof. In the housing 10, the upper surface 10a is formed as a trapezoidal solid body that inclines to the front side (a first side surface side) of the POS terminal 1.

The first connecting section 11 is formed in a cylindrical shape. The first connecting section 11 is integrally molded to the housing 10. The first connecting section 11 is coupled to the display unit 3.

For example, a shaft body as a rotating shaft is inserted into the first connecting section 11. The first connecting section 11 is extended to one portion of a side section on an upper end side of the upper surface 10a of the housing 10 with an axis direction of the first connecting section 11 set along the side section on the upper end side of the upper surface 10a.

The sensor unit 12 detects the position of the display unit 3. The sensor unit 12 is a detecting unit. As shown in FIGS. 2 to 4, the sensor unit 12 is provided in the other portion of the side section on the upper end side of the upper surface 10a. The sensor unit 12 includes plural switches.

Specifically, the sensor unit 12 includes a first switch 16 and a second switch 17. The sensor unit 12 also includes a sensor controller 58 connected to the first and second switches 16 and 17.

As the first and second switches 16 and 17, for example, ON-OFF switches configured to pivot or swing to mechanically switch conduction and non-conduction are used. As shown in FIG. 4, each of the first and second switches 16 and 17 includes a swinging section 20 configured to pivot or swing, a detecting section 21 configured to detect the movement of the swinging section 20, and the signal line S connected to the detecting section 21. The signal line S is connected to the sensor controller 58.

Each of the first and second switches 16 and 17 is turned on when the swinging section 20 is pressed to swing to the detecting section 21 side. Each of the first and second switches 16 and 17 is turned off in a free state of the swinging section 20. As the first and second switches 16 and 17, proximity sensors may be used instead of the ON-OFF switches.

The display unit 3 includes a display 30, second connecting sections 31 connected to the first connecting section 11, and the operation sections 32 configured to operate the sensor unit 12.

As the display 30, a touch panel display having a touch panel function is used. The display 30 has a function of a GUI (Graphical User Interface) capable of performing both display of processing content and operation input.

The second connecting sections 31 are formed in a cylindrical shape or a columnar shape having a curved surface. The shaft body as the rotating shaft is inserted into the second connecting sections 31. Each of the second connecting sections 31 is extended to one portion of a side section on one end side of the display unit 3 with an axis direction of the second connecting section 31 set along the side section on one end side of the display unit 3. The second connecting sections 31 are respectively provided on both end sides of the first connecting section 11. The second connecting sections 31 are connected to the first connecting section 11 by inserting the shaft body into the second connecting sections 31.

That is, the shaft body inserted into the second connecting sections 31 is the same as the shaft body inserted into the first connecting section 11. The second connecting sections 31 are located on an axis same as that of the first connecting section 11. The first and second connecting sections 11 and 31 are pivotably coupled on the axis C of the shaft body that is a rotation center shown in FIG. 3. According to the coupling of the first connecting section 11 and the second connecting sections 31, the display unit 3 pivots around the axis C with respect to the base unit 2. It is also possible to provide a pair of semispherical recesses and projections in the first connecting section 11 and the second connecting sections 31 and couple the first connecting section 11 and the second connecting sections 31 by combining the projections and recesses with no use of the shaft body.

As shown in FIG. 3, the operation sections 32 are provided in the second connecting section 31 in a number same as the number of switches of the sensor unit 12. Two operation sections 32 project on a curved surface section of the second connecting section 31.

The two projecting operation sections 32 are a first operation section 33 configured to operate the first switch 16 and a second operation section 34 configured to operate the second switch 17. The first and second operation sections 33 and 34 respectively interfere with the switches 16 and 17 in pivoting positions different from each other when the second connecting section 31 pivots.

The first operation section 33 is arranged away from the second operation section 34 by a predetermined angle in a pivoting direction of the second connecting section 31. The first and second operation sections 33 and 34 are formed on the curved surface of the second connecting section 31 that passes the switches 16 and 17 when the second connecting section 31 pivots.

Specifically, when the display unit 3 comes into contact with the upper surface 10a of the base unit 2, the first operation section 33 comes into contact with the first switch 16 to turn on the first switch 16. When the display unit 3 pivots and separates from the base unit 2, the first operation section 33 separates from the first switch 16 to turn off the first switch 16. The first operation section 33 projects in a predetermined position on the surface of the second connecting section 31 where the first operation section 33 can turn on and off the first switch 16. The position on the display unit 3 where the first switch 16 and the first operation section 33 come into contact with each other is one of plural predetermined positions on the display unit 3.

When the display unit 3 pivots from the base unit 2 by a predetermined angle and separates from the base unit 2 by a predetermined distance, the second operation section 34 comes into contact with the second switch 17 to turn on the second switch 17. The second operation section 34 is provided in the second connecting section 31. A position on the display unit 3 where the second switch 17 and the second operation section 34 come into contact with each other is one of the plural predetermined positions on the display unit 3.

The predetermined distance (the predetermined angle) by which the display unit 3 separates from the base unit 2 is a distance by which the display unit 3 separates from the base unit 2 to enable the display 30 to be visually recognized from the rear side (a second side surface side) of the POS terminal 1 (the base unit 2). The distance may be a moving distance of the display unit 3 or may be a pivoting angle of the display unit 3. In this embodiment, the predetermined distance for enabling the display 30 to be visually recognized from the rear side of the POS terminal 1 is explained as a distance from the upper surface 10a of the base unit 2 to a position where the display unit 3 is in an upright state. The predetermined distance or the predetermined angle is not limited to this.

In other words, the second operation section 34 turns on the second switch 17 in the position where the display 30 can be visually recognized from the rear side of the base unit 2. The second operation section 34 turns off the second switch 17 in a position where the display unit 3 is not upright.

The connecting mechanism 4 includes the first connecting section 11, the second connecting sections 31, and the shaft body inserted through the center of the first connecting section 11 and the second connecting sections 31. The connecting mechanism 4 is a hinge mechanism that is provided on the upper end side of the base unit 2 and one end side of the display unit 3 and pivots the display unit 3 with respect to the base unit 2. The connecting mechanism 4 may have a lock mechanism for regulating the movement of the display unit 3 and releasing the regulation in a position where the base unit 2 comes into contact with the display unit 3 and a position where the display unit 3 is in a substantially upright state.

As shown in a block diagram of the POS terminal 1 in FIG. 5, the POS terminal 1 is mounted with a CPU 50 as a core of control. The CPU 50 is a control unit. A ROM (Read Only Memory) 51, a RAM (Random Access Memory) 52, a BIOS-ROM (Basic Input/Output System-Read Only Memory) 53, a display controller 54, a hard disk (HDD) 55, a communication interface (I/F) 56, a printer controller 57, and a sensor controller 58 are connected to the CPU 50 via the bus line B of an address bus via a chip set. The bus line B may be a data bus.

The chip set includes a north bridge and a south bridge. The north bridge controls information distribution such as management of data exchange and connects the CPU 50 and the bus line B. The south bridge has functions of various controllers. The ROM 51 has stored therein in advance a computer program for causing the CPU 50 to execute control operation. The ROM 51 may include a computer program for executing control operation other than the control operation of the CPU 50 or other computer programs. The RAM 52 forms various memory areas used for arithmetic processing by the CPU 50.

The BIOS-ROM 53 records test programs that are executed when the respective kinds of hardware are initialized. The test programs are a POST (Power-On Self Test), a BIOS driver, and a VGA (Video Graphics Array) driver. The test programs may be test program other than the POST, the BOIS driver, and the VGA driver.

The display controller 54 controls the display 30 to display a message and the like. The display controller 54 captures input data corresponding to touch operation of the display 30 of the touch panel type by a user.

The hard disk 55 stores various databases and various programs necessary for settlement of transaction processing. The communication I/F 56 is connected to, for example, a client server system. The communication I/F 56 may be connected to peripheral equipment. The peripheral equipment is, for example, a drawer.

The printer controller 57 controls to drive the printer 13. The printer 13 is a so-called thermal printer including a platen cover, a platen roller, and a thermal head as components. The sensor controller 58 detects operation (on and off) of the sensor unit 12 provided in the base unit 2.

The CPU 50 has, as a main function, a control function for detecting the position of the display unit 3 and performing change of a display direction of the display 30, i.e., change of display information of the display 30. Specifically, the CPU 50 receives information concerning the operation of the sensor unit 12 detected by the sensor controller 58. The operation of the sensor unit 12 is any one of turn-on of the first switch 16, turn-on of the second switch 17, and turn-off of both the first and second switches 16 and 17. The operation of the sensor unit 12 is the detection of the position of the display unit 3.

The CPU 50 instructs, on the basis of the received information concerning the operation of the sensor unit 12, the display controller 54 to change display information to be displayed.

When the operation information of the sensor unit 12 is the turn-on of the first switch 16, the display controller 54 displays, on the basis of an instruction from the CPU 50, the display information on the display 30 with the connecting mechanism 4 side set as the upper side. When the display information is displayed on the display 30 with the connecting mechanism 4 side set as the upper side, the display is hereinafter referred to as display by a regular position. In the display by the regular position, concerning a position where an operator visually recognizes the display 30, information is displayed with the connecting mechanism 4 side set as the upper side when the display unit 3 is brought into contact with the base unit 2.

When the operation information of the sensor unit 12 is the turn-on of the second switch 17, the display controller 54 displays, on the basis of an instruction from the CPU 50, the display information on the display 30 with the connecting mechanism 4 side set as the lower side. When the display information is displayed on the display 30 with the connecting mechanism 4 side set as the lower side, since the display information is displayed vertically reversed from the display by the regular position, the display is hereinafter referred to as display by a reverse position.

When the operation information of the sensor unit 12 is the turn-off of both the first and second switches 16 and 17, the display controller 54 controls the display 30 not to perform display assuming that the display unit 3 is located between predetermined positions. The display controller 54 may stop the supply of electric power to the display 30. Instead of the non-display of the display 30 or the stop of the power supply to the display 30, the display controller 54 may darken the display by the display 30. However, the non-display or the stop of the power supply is desirable when a reduction in power consumption is taken into account.

The pivoting of the display unit 3 of the POS terminal 1 configured as explained above and the display by the display unit 3 are explained with reference to a flowchart shown in FIG. 6.

First, power is supplied to the POS terminal 1 and the POS terminal 1 is activated (Act 1). When the POS terminal 1 is activated, the sensor controller 58 checks on and off states of the first switch 16 and the second switch 17 as states of the sensor unit 12.

The sensor controller 58 determines whether the first operation section 33 operates the first switch 16, i.e., whether the first switch 16 is on (Act 2). The determination concerning whether the first switch 16 is on is determination concerning whether the display unit 3 is in contact with the base unit 2.

If the first switch 16 is on (YES in Act 2), the CPU 50 receives this information from the sensor controller 58 and displays display information on the display 30 in the regular position (Act 3). At this point, the display unit 3 is in contact with the base unit 2. The display 30 is located on the operator side.

The display information displayed on the display 30 of the display unit 3 is operation information and processing information. The operation information is operation of a ten key or a touch key. The processing information is commodity information and a processing guide. The display information may be information other than the operation information and the processing information.

Simultaneously with the display of the display unit 3 in the regular position, the CPU 50 monitors a stop instruction, for example, operation (instruction) for shutdown of the POS terminal 1 (Act 4). If the operation (instruction) for shutdown of the POS terminal 1 is received (YES in Act 4), the CPU 50 stops the POS terminal 1 (Act 5). Such stop of the POS terminal 1 is mainly performed after the store is closed.

If the stop instruction is not received (NO in Act 4), the CPU 50 checks a state of the sensor unit 12 (Act 2).

If the first switch 16 is continuously on (YES in Act 2), the information is continuously displayed on the display 30 in the regular position until the stop instruction is received (YES in Act 4) or the first switch 16 is turned off. When the first switch 16 is continuously on, for example, the operator is operating the POS terminal 1.

If the first switch 16 is off (NO in Act 2), the sensor controller 58 checks a state of the second switch 17 and determines whether the second switch 17 is off (Act 6).

If the second switch 17 is not operated (YES in Act 6), the sensor controller 58 determines that both the first and second switches 16 and 17 are off. When both the first and second switches 16 and 17 are off, since the display unit 3 is pivoting, the display 30 is set non-display (Act 7). In other words, the display unit 3 displays nothing on the display 30.

In this state, the CPU 50 monitors a stop instruction, for example, operation for shutdown of the POS terminal 1 (Act 4). Operation same as that explained above is performed in Act 4 and subsequent steps.

If the swinging section 20 of the second switch 17 is operated by the second operation section 34 (NO in Act 6), the sensor controller 58 determines that the first switch 16 is off and the second switch 17 is on. When the first switch 16 is off and the second switch 17 is on, the CPU 50 displays information on the display 30 in the reverse position (Act 8).

The display unit 3 pivots from a state of contact with the base unit 2 and changes to an upright state. Since the display 30 of the display unit 3 is arranged on the customer side, a customer can visually recognize the display 30 from the rear surface side of the POS terminal 1. At this point, display information such as operation information or processing information same as that displayed when the first switch 16 is on (YES in Act 2) is displayed on the display 30 of the display unit 3 as the reverse position display vertically reversed from the regular position display.

With the POS terminal 1 configured as explained above, the display on the display unit 3 is changed according to on and off of the first and second switches 16 and 17.

Specifically, when the display unit 3 comes into contact with the upper surface of the base unit 2, the first operation section 33 turns on the first switch 16. The CPU 50 displays information on the display 30 with the connecting mechanism 4 side of the display 30 set as the upper side. When the display unit 3 pivots in a direction away from the base unit 2 by a predetermined distance and the display 30 is arranged on the rear side of the POS terminal 1, the second operation section 34 turns on the second switch 17. The CPU 50 displays information on the display 30 with the second connecting section 31 side of the display 30 set as the lower side.

In this way, when the first switch 16 is on and when the second switch 17 is on, the display information displayed on the display 30 is vertically reversed. Therefore, in the POS terminal 1, the display 30 of the display unit 3 is arranged on one of the front side and the rear side of the POS terminal 1. This makes it possible to visually recognize and operate the display 30 from the front side and the rear side.

Not only the operator of the POS terminal 1 but also an outsider such as a customer faces the display 30 on a pivoting side such as the rear side of the POS terminal 1. Therefore, the POS terminal 1 is well visually recognized and easily operated in places other than the front side. In this way, visibility and operability of the POS terminal 1 are improved.

When the first switch 16 and the second switch 17 are off, the display of the display 30 is set as non-display or the supply of electric power to the display 30 is stopped. Consequently, when the display unit 3 is pivoted or when the display unit 3 is located in the positions where the first and second switches 16 and 17 are turned off, power consumption is reduced. The POS terminal 1 reduces power consumption and saves power.

As explained above, with the POS terminal 1 according to this embodiment, the display of the display 30 is vertically reversed when the display 30 is directed to the front side of the POS terminal 1 and when the display 30 is directed to the rear side of the POS terminal 1. Therefore, the visibility and the operability are improved. The POS terminal 1 can be easily operated from plural positions and has high visibility.

The present invention is not limited to the embodiment explained above. In the example explained above, the CPU 50 detects the position of the display unit 3 using the sensor unit 12 and vertically reverses the display of the display 30. However, the present invention is not limited to this. For example, the CPU 50 may change, according to the position of the display unit 3, information to be displayed rather than simply vertically reversing the display of the display 30. This modification is explained below.

The CPU 50 further has a control function for changing operation information and processing information displayed on the display 30 on the basis of on and off states of the first switch 16 and the second switch 17 in addition to the control function for detecting the position of the display unit 3 and performing change of a display direction of the display 30. For example, the RAM 52 (or the HDD 55) has a computer program for causing the display 30 to display information in two layouts. The number of layouts does not have to be two as long as the RAM 52 has plural layouts of information to be displayed on the display 30.

One of the layouts is a layout in which information for the operator is displayed on the display 30 located in the front on the POS terminal 1 side. In the layout for the operator, for example, product information required by the operator such as a product name, a price, purchase cost, a discount rate, and a purchase schedule and operation input keys such as a ten key, a receipt issue key, and a sub-total key are displayed.

The other layout is a layout in which information for the customer is displayed on the display 30 located in the rear on the POS terminal 1 side. In the layout for the customer, for example, product information displayed to the customer such as a product name, a price, a discount rate, and a discount price and operation input keys such as a ten key for secret code input and a point card selection key are displayed.

By adopting such a configuration, the CPU 50 displays the information for the operator on the display 30 in the regular position in Act 3 of the flowchart shown in FIG. 6. The CPU 50 displays the information for the customer on the display 30 in the reverse position in Act 8 of the flowchart shown in FIG. 6.

Specifically, the CPU 50 pivots the display unit 3 and locates the display unit 3 in different predetermined positions to display different kinds of information on the display 30. Since the layout for the customer is displayed on the display 30 visually recognized by the customer in this way, the customer visually recognizes necessary information from the display 30 and directly operates the display 30. Therefore, the customer can input a secret code of a credit card and input an instruction for using points of a point card. For example, for the purpose of customer attraction, a service of a so-called customer participation type can be provided in which, as a privilege in shopping, points are given to the customer when the customer operates the display 30 in purchasing commodities. In this way, different kinds of information are displayed on the display 30 in plural predetermined positions. Consequently, universality of the POS terminal 1 is improved.

In the example explained above, when both the first and second switches 16 and 17 are off, the display 30 is set non-display. However, the present invention is not limited to this. For example, it is also possible that a computer program for causing the display 30 to display information to be displayed is provided in the RAM 52 (or the HDD 55) and the CPU 50 causes the display 30 to display the information. For example, when the display unit 3 pivots and both the first and second switches 16 and 17 are off, a logo of the store, sales information, and the like may be displayed. Further, as explained above, the display 30 may be darkened.

Further, in the example explained above, the first and second operation sections 33 and 34 are provided to be arranged such that the first and second switches 16 and 17 are not turned on simultaneously (together). In other words, the first and second switches 16 and 17 are configured to be arranged not to be turned on together. However, a function for displaying an error on the display 30 when both the first and second switches 16 and 17 are turned on because of a failure or the like may be provided in the CPU 50.

The sensor unit 12 includes the first and second switches 16 and 17. However, the present invention is not limited to this. The sensor unit 12 may includes two or more switches. The POS terminal 1 includes a checkout terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A POS terminal comprising:
a base unit;
a display unit including a display;
a connecting mechanism configured to connect the display unit to the base unit, the display unit pivoting with respect to the base unit;
a detecting unit configured to detect a position of the pivoted display unit in plural predetermined positions; and
a control unit configured to display information on the display when the display unit is located in any one of the predetermined positions.

2. The POS terminal according to claim 1, wherein
the plural predetermined positions of the display unit are two positions where the display can be visually recognized from each of a first side surface side of the base unit and a second side surface side opposed to the first side surface side, and
the control unit displays the information on the display in the predetermined positions.

3. The POS terminal according to claim 2, wherein the control unit performs different kinds of display on the display in the plural predetermined positions.

4. The POS terminal according to claim 3, wherein the connecting mechanism is a hinge that has connecting sections respectively provided in the base unit and the display unit and coupled to each other and pivots the display unit with respect to the base unit.

5. The POS terminal according to claim 4, wherein the detecting unit includes plural switches configured to respectively conduct in the plural predetermined positions and detect a position of the display unit according to conduction and non-conduction of the switches.

6. The POS terminal according to claim 5, wherein the detecting unit includes swinging sections configured to swing to mechanically switch the conduction and the non-conduction.

7. The POS terminal according to claim 6, wherein
the detecting unit is provided on an upper surface of the base unit, and
the display unit includes plural operating sections provided in a connecting section thereof and configured to respectively operate the swinging sections when the display unit is located in the two positions.

8. The POS terminal according to claim 7, wherein the control unit sets the display of the display as non-display between the two positions.

9. The POS terminal according to claim 1, wherein the display is a touch panel.

10. The POS terminal according to claim 1, further comprising a printer provided on an upper surface of the base unit.
